(19) United States
(12) Patent Application Publication
(10) Pub. No.: US 2014/0220227 A1
(43) Pub. Date: Aug. 7, 2014

(54) ANIMAL CHEW PRODUCTS AND PROCESSES

(71) Applicant: Joe Crump, Caledon East (CA)

(72) Inventor: Joe Crump, Caledon East (CA)

(21) Appl. No.: 13/758,983

(22) Filed: Feb. 4, 2013

(51) Int. Cl. A23K 1/14

(52) U.S. Cl. CPC A23K 1/143
USPC 426/635; 426/473; 426/472

(57) ABSTRACT

An animal chew product and processes for making animal chew products is provided. A process includes baking at least one sweet potato to reach a conversion temperature for a time sufficient to generally uniformly convert starch in the at least one sweet potato to sugar; slicing the baked at least one sweet potato into segments of desired shape and thickness; and applying heat at a drying temperature that is below the burning point of the sugar for a time sufficient to dry the segments to a threshold moisture level.

### FIELD OF THE INVENTION

The present invention relates generally to animal chew products and specifically to an animal chew products made from sweet potato and processes for making animal chew products.

### BACKGROUND OF THE INVENTION

Dogs and other animals enjoy chewing on tough objects. Accordingly, a great deal of research and development has been directed at producing animal chew products for consumer and veterinary markets that are desirable to animals and/or promote the animals' health.

U.S. Pat. No. 4,892,748 to Anderson et al. discloses a low calorie pet treat composed of food grade cellulose, a unique binder system, colour and salt ingredients melded together into a desired shape.

U.S. Pat. No. 5,431,927 to Hand et al. discloses a pet food product prepared from a fibre containing nutritionally balanced mixture of carbohydrate protein, fat, vitamins and minerals exhibiting a mechanical tooth cleansing function for reduction of plaque.

U.S. Pat. No. 5,501,868 to Collings et al. discloses an extruded dog treat food product having improved resistance to breakage.

U.S. Pat. No. 5,500,239 to Hayward discloses a method and apparatus for the manufacture of a pet food product having a fibrous striated structural matrix.

U.S. Pat. No. 6,126,978 to Axelrod discloses an edible dog chew comprised of injection molded potato starch, calcium carbonate and a fruit flavouring, food coloring or breath sweetener.

U.S. Pat. No. 6,060,100 to Koller discloses a pet chew treat made from the gastro-intestinal organs of a bison.

U.S. Pat. No. 6,228,418 to Gluck et al. discloses a pet treat made with corn flour and a palatability enhancer such as vegetable digest, liver digest, poultry digest, beef digest, and other ingredients.

PCT Patent Application Publication No. WO 2012/052425 to Lund et al. discloses a chewable product for humans or animals having improved chew resistance due to the incorporation of hydrocolloids, sweeteners and humectants within a carbohydrate mix.

While extruded and injection-molded chew products made from combinations of various ingredients including sweeteners and flavourings are known, improvements in processes for making chew products having primarily natural ingredients are increasingly desirable.

U.S. Pat. No. 7,537,794 to Baldus discloses a digestible animal chew made from a dehydrated sweet potato. The animal chew is described as non-allergenic and as having a striated, deeply furrowed surface to improve the oral hygiene of the animal. The animal chew also described as low in calories, high in vitamins, minerals and fibre and as containing no animal-based or synthetic products. The process by which the animal chew is made also disclosed in the patent, and generally includes steps of segmenting, blanching and dehydrating the sweet potato.

U.S. Pat. No. 4,632,834 to Barnes discloses a frozen sweet potato product and process for its production. The process involves slicing unpeeled sweet potatoes in a direction perpendicular to their longitudinal axes, blanching the slices for 1 to 1.5 minutes in water of about 200° Fahrenheit (F), cooling the blanched slices and applying orange juice to the slices prior to quick freezing.

U.S. Pat. No. 5,118,518 to Hattori et al. discloses a method for manufacturing very thin, dried sweet potato chips having a thickness on the order of 1 mm or less. The method includes heating raw sweet potatoes at a temperature ranging from 70° Celsius (C) to 100° C. to adjust hardness of the sweet potatoes to 1,800 to 12,000 and then slicing the heated sweet potatoes to a desired thickness. This primary heat treatment is purported to enhance the activity of β-amylase present in the sweet potato to increase the amount of maltose produced and thereby sufficiently bring out the sweetness of the sweet potato while permitting slicing into thin slices on the order of 0.3 to 1 mm The patent indicates that the primary heat treatment is preferably carried out by hot water immersion and steam cooking techniques. A second heat treatment is conducted after the slicing to convert starches present in the sweet potato to a-starches (gelatinized starches).

U.S. Pat. No. 6,601,539 to Snook discloses a vegetable based animal chew, animal chew toy, and method of making the same comprising cutting a vegetable such as a sweet potato into slices, removing a cylindrical core from the slices, dehydrating the slices, and arranging the dehydrated slices on a cord.

U.S. Pat. No. 2,769,714 to Stahmer discloses cooked sliced potato products having one side of a corrugated configuration and the other side of a flat configuration, and a method for making the potato product.

Various processes exist for dehydrating vegetable products for packaging, freezing and later rehydration, or for otherwise preparing the vegetable products. For example, U.S. Pat. No. 871,962 to Cooke discloses a process of dehydrating animal and vegetable substances.

U.S. Pat. No. 3,295,995 to Bright et al. discloses a process of dehydrating vegetables.

U.S. Pat. No. 3,794,500 to Lazar et al. discloses a process by which inner core enzymes in a fruit or vegetable product may be deactivated through blanching.

French Patent Application Publication No. 2,769,472 discloses recipes for producing thinly sliced fruits or vegetables.

U.S. Pat. No. 6,468,573 to Herrick et al. discloses a process for making rehydratable food pieces using impingement drying.

While various animal chew products and food preparation processes are known, improvements are desirable for providing sweet-tasting, tough and nutritious animal chew products from sweet potatoes.

### SUMMARY OF THE INVENTION

According to an aspect, there is provided a process for making animal chew products, comprising baking at least one sweet potato to reach a conversion temperature for a time sufficient to generally uniformly convert starch in the at least one sweet potato to sugar; slicing the baked at least one sweet potato into segments of desired shape and thickness; and applying heat at a drying temperature that is below the burning point of the sugar for a time sufficient to dry the segments to a threshold moisture level.

In an embodiment, during the baking substantially all of the starch in the sweet potato is converted to sugar.

According to another aspect, there is provided a process for making animal chew products, comprising baking at least one sweet potato to reach an internal temperature of about 170° F. to about 210° for a time sufficient for the flesh in the sweet potato to significantly soften while retaining its structure; slicing the baked at least one sweet potato into segments of desired shape and thickness; and applying heat at a drying temperature that is below the burning point of the sugar for a time sufficient to dry the segments to a threshold moisture level.

In an embodiment, the threshold moisture level is about 8% to about 20%.

According to another aspect, there is provided a process for making animal chew products, comprising baking at least one sweet potato to reach a conversion temperature for a time sufficient to generally uniformly convert starch in the at least one sweet potato to sugar while retaining sufficient structure in the at least one sweet potato to permit its slicing into segments of a desired shape and thickness; slicing the baked at least one sweet potato into the segments; and applying heat at a drying temperature that is below the burning point of the sugar for a time sufficient to dry the segments to a threshold moisture level.

In an embodiment, the thickness of the segments is about 0.5 inches prior to being dried.

According to another aspect, there is provided animal chew products made according to the above-described processes.

### BRIEF DESCRIPTION OF THE DRAWINGS

Embodiments of the invention will now be described with reference to the appended drawings in which:

FIG. 1 is a flow diagram of a process for making animal chew products according to an embodiment;

FIG. 2 is a flow diagram showing further detail of the baking; and

FIG. 3 is a flow diagram showing further detail of the drying.

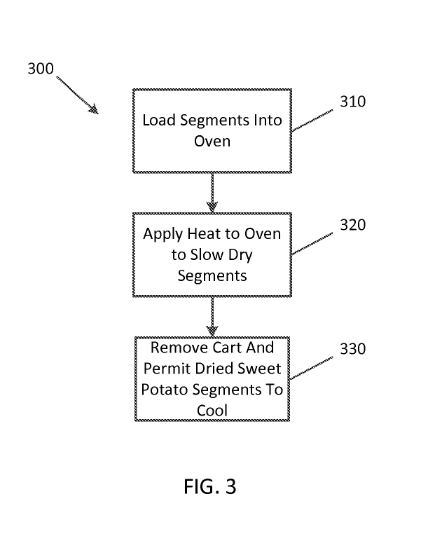

### DETAILED DESCRIPTION

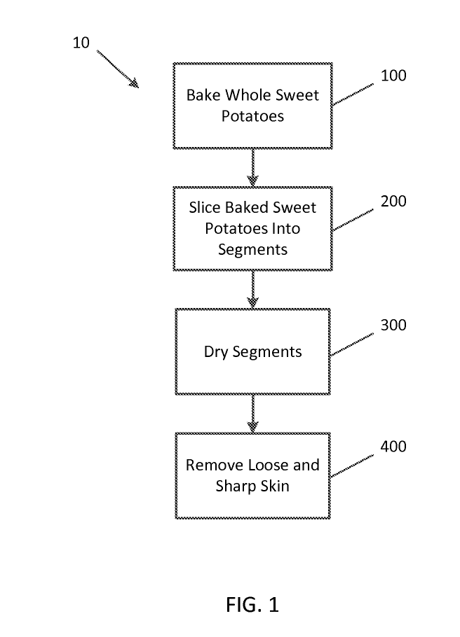

Turning now to FIG. 1, a process for making sweet-tasting, tough and nutritious animal chew products from sweet potatoes is shown generally at 10. During the process, raw sweet potatoes, having been previously washed to remove dirt and other contaminants, are baked whole with skin and all, to reach a conversion temperature for a time sufficient to generally uniformly convert starch in the at least one sweet potato to sugar (step 100). The baked sweet potatoes are then sliced into segments of desired shape and thickness (step 200). Heat is then applied at a drying temperature that is below the burning point of the sugar for a time sufficient to dry the segments to a threshold moisture level (step 300). Finally, loose and sharp pieces of the skin are removed to improve both the look and the texture of the segments (step 400).

It is preferred that orange-fleshed sweet potatoes, such as Beauregard, Covington, Jewels, Garnet, Morning Glory, Redskin and Evangeline varieties be processed according to the invention. However, the process may be applied to other varieties of sweet potato.

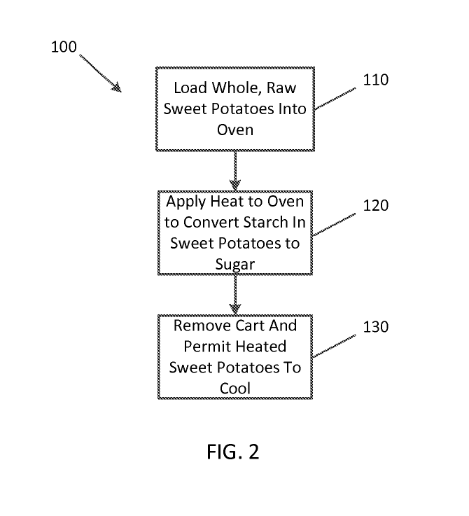

FIG. 2 is a flow diagram showing further detail of the baking. It is desirable to strike a balance between maximizing sweetness of the animal chew being made and maintaining ease of slicing into segments. Slicing sweet potatoes into segments prior to baking results in exposure of the inner flesh of the sweet potatoes directly to the external heat being applied. The heat permeating the exposed flesh directly immediately converts starches in the surface of the flesh to sugars, but continued application of the heat to permeate to the inner flesh can result in burning of the sugars in the surface before the underlying flesh can be exposed to a suitable amount of heat for its respective starch to sugar conversion. It is undesirable to burn the sugars as it negatively affects the taste of the animal chew.

It has been found that desirable starch to sugar conversion without undue burning of the resultant sugar can be done by baking the whole sweet potato, with skin, prior to slicing into segments. The skin itself contains nutrients, and leaving skin as part of the end product contributes to its natural look. Furthermore, without wishing to be bound to a particular theory, it is believed that, within certain temperature ranges, the skin distributes heat in a way to reduce the rate at which the sugar conversion at the outermost flesh occurs. As such, conversion of sugars in the sweet potato occurs more uniformly, lessening or eliminating the burning of resultant sugars. However, it has also been found that baking for too long while attempting to assure absolute maximum sweetness can bring about the problem of rendering the flesh of the sweet potato to be too mushy for proper slicing into discrete segments suitable for an animal chew product. For animal chew products such as are described herein, it is desirable to retain sufficient structure in the sweet potatoes after baking so as to permit their subsequent slicing into segments of the desired thickness prior to drying.

The present inventor has found that a suitable balance between sweetness and ease of slicing into the desired thicknesses after baking is achieved by baking sweet potatoes whole, with skin, at an oven temperature of about 380° F. to about 420° F. for about 80 to about 100 minutes, using a convection oven. It has been found that baking the orange-fleshed sweet potatoes at about 400° F. for about 90 minutes with this type of oven causes the sweet potatoes to have a uniform, deep-orange flesh that is both sliceable and suitably sweet. The cooking time will vary depending on the batch size.

It will be understood that there are a large range of different ovens that could be used, and each may exhibit different capabilities, heating times and temperature variability within their interiors. It is preferred that the oven be controlled to produce heat such that the core temperature of the sweet potatoes reaches a conversion temperature of about 170° F. to about 210° F., and more preferably about 180° F. to about 200° F., and even more preferably about 190° F. It will be appreciated that greater consistency in the sweetness, texture and appearance of the animal chew products are achieved when the range of core temperatures across sweet potatoes is smaller. During this step amylase and amylopectin molecules associate with one another to form a gel. The gel, it is believed, is chiefly responsible for the tough chewy texture of the product after the final drying process (step 130).

Another indicator of the suitable baking time is the peripheral hardness of the baked sweet potato. With baking, the sweet potato is softened significantly because of the partial breakdown of starch and cellular structures occurring when the baking heat is applied. The degree of firm to soft conversion is largely correlated with the extent of starch degradation by amylase. It is preferable for a baked sweet potato to be noticeably softer to the touch, but is not so soft as to be mushy to the extent of being difficult to subsequently slice into segments. As a rough indication, it has been found that a reduction in hardness to the point of being able to squeeze a thumb and index finger together through the sweet potato, with moderate resistance from the sweet potato, after baking corresponds to a sweet potato having a healthy-looking deep-orange flesh, that is suitably sweet, and that retains sufficient structure to be sliceable into the desired thicknesses without undue crumbling. Uniformity of structure is also desirable. If not baked enough, the flesh will be a lighter orange, and will be less uniform in colour. In this circumstance, the flesh of the undercooked sweet potato may be observed to have white patches where unconverted starch remains. Due to inconsistent starch conversion to maltose and dextrin the insufficiently baked sweet potato chew will not have a uniform structure, and will therefore tend to crumble rather than exhibit a more chewy consistency.

During baking, the whole, raw, sweet potatoes are loaded onto trays to form a single layer per tray so that the periphery of the sweet potatoes will be substantially entirely exposed to the heat. Several loaded trays are placed on a cart, which is then rolled into an oven (step 110). Heat is then applied to the oven at a temperature and for a time as described above (step 120). With the baking completed, the cart is removed from the oven, and the baked sweet potatoes on their respective trays are permitted to cool somewhat (step 130).

Further detail of the slicing of the baked sweet potatoes (step 200) is now provided. Preferably, the slicing is done lengthwise so as to render larger and more consistently-sized segments. Also, preferably the segments are about 0.5 inches thick, though variations in thickness are possible. The slicing may be done manually, but preferably a machine such as an electrically powered slicer suitable for slicing bread and the like is employed to help automate the slicing. The multiple blades of the slicer, arranged in parallel with each other approximately 0.5 inches apart, reciprocate up and down or run in a single direction like a band saw. During the slicing, the sweet potatoes are advanced into contact with the blades and are each sliced into several 0.5 inch segments in a single pass. The segments are removed from the vicinity of the slicer for further processing, as will be described. It will be understood that various other slicing methods and machines may be employed as alternatives.

With the baked sweet potatoes having been sliced into segments, the segments are then dried (step 300). Advantageously, drying is conducted in such a way so as to cause the segments to reach a moisture level of about 8% to about 20% as quickly as possible without burning the sugar in the segments by applying heat at too high a temperature. It has been found that drying the segments at a drying temperature below the burning point of the sugar, preferably about 165° F. to about 175° F. for about 14 to about 18 hours, and preferably about 16 hours, satisfactorily reduces the moisture to the desired range within an acceptable time frame without undue burning of the sugar.

FIG. 2 is a flow diagram showing further detail of the drying. The segments are loaded onto drying trays to form a single layer per tray so that the periphery of the segments will be substantially entirely exposed to the heat. Several loaded drying trays are placed on a cart, which is then rolled into an oven (step 310). Heat is then applied to the oven at a temperature and for a time as described above (step 320). Preferably air is moved within the oven to provide uniformity of heat throughout the drying process. With the drying completed, the cart is removed from the oven, and the dried segments on their respective trays are permitted to cool (step 330).

Further detail of the removal of loose and sharp skin (step 400) is now provided. With the segments having been dried as described above, sharp and loose dried skin is removed in order to smooth the edges of the segments, improving the appearance and texture of the resultant animal chew products. In this embodiment, removal of the sharp and loose dried skin is done by tumbling the dried segments. Preferably, the tumbling includes placing the dried segments into a tumbling apparatus having exit holes that are smaller than the size of the dried segments. The tumbling apparatus could be a drum with exit holes, which is either automatically or manually rotated to tumble the dried segments. When the dried segments are tumbled into each other or against the interior of the drum, the sharp and loose segments break loose and fall out of the exit holes to be discarded, while the dried segments are retained within the drum. After a suitable amount of tumbling, the dried and tumbled segments, having the sharp and loose dried skin removed may be removed from the tumbling apparatus and packaged. It will be understood that much of the skin, having clung to the dried segments, will remain to provide the natural appearance and additional nutritional benefits.

Although embodiments have been described with reference to the drawings, those of skill in the art will appreciate that variations and modifications may be made without departing from the spirit and scope thereof as defined by the appended claims.

What is claimed is:

1. A process for making animal chew products, comprising:
baking at least one sweet potato to reach a conversion temperature for a time sufficient to generally uniformly convert starch in the at least one sweet potato to sugar;
slicing the baked at least one sweet potato into segments of desired shape and thickness; and
applying heat at a drying temperature that is below the burning point of the sugar for a time sufficient to dry the segments to a threshold moisture level.

2. The process of claim 1, wherein the conversion temperature is about 170° F. to about 210° F.

3. The process of claim 1, wherein the conversion temperature is about 180° F. to about 200° F.

4. The process of claim 1, wherein the conversion temperature is about 190° F.

5. The process of claim 1, wherein the baking comprises baking the at least one sweet potato in an oven having a temperature of about 400° F. for about 90 minutes.

6. The process of claim 1, wherein the threshold moisture level is about 8% to about 20%.

7. The process of claim 1, wherein the drying temperature is about 165° F. to about 175° F.

8. The process of claim 7, wherein the time sufficient to dry the segments to the threshold moisture level is about 12 to about 18 hours.

9. The process of claim 1, wherein the time sufficient to dry the segments to the threshold moisture level is about 16 hours.

10. The process of claim 1, further comprising:
during applying heat to the segments, causing air to flow about and around the segments.

11. The process of claim 1, further comprising:
removing sharp and loose skin from the dried segments.

12. The process of claim 11, wherein removing sharp and loose skin from the dried segments comprises tumbling the dried segments.

13. The process of claim 12, wherein tumbling the dried segments comprises:
placing the dried segments into a tumbling apparatus having exit holes;
activating the tumbling apparatus to remove the sharp and loose skin; and
permitting removed skin to exit from the tumbling apparatus via the exit holes.

14. The process of claim 1, wherein during the slicing, the baked sweet potatoes are sliced into segments having a thickness of about 0.5 inches.

15. The process of claim 1, wherein substantially all of the starch in the at least one sweet potato is converted to sugar.

16. A process for making animal chew products, comprising:
baking at least one sweet potato to reach an internal temperature of about 170° F. to about 210° for a time sufficient for the flesh in the sweet potato to significantly soften while retaining its structure;
slicing the baked at least one sweet potato into segments of desired shape and thickness; and
applying heat at a drying temperature that is below the burning point of the sugar for a time sufficient to dry the segments to a threshold moisture level.

17. The process of claim 16, wherein the baking comprises baking at least one sweet potato to reach a desired hardness.

18. The process of claim 16, wherein the baking comprises baking at least one sweet potato to reach an internal temperature of about 190° F. for the sufficient time.

19. The process of claim 16, wherein the baking comprises baking the at least one sweet potato in an oven having a temperature of about 400° F. for about 90 minutes.

20. The process of claim 16, wherein the threshold moisture level is about 8% to about 20%.

21. The process of claim 16, wherein the drying temperature is about 165° F. to about 175 F.

22. The process of claim 21, wherein the time sufficient to dry the segments to the threshold moisture level is about 12 to about 18 hours.

23. The process of claim 16, wherein the time sufficient to dry the segments to the threshold moisture level is about 16 hours.

24. The process of claim 16, further comprising:
during applying heat to the segments, causing air to flow about and around the segments.

25. The process of claim 16, further comprising:
removing sharp and loose skin from the dried segments.

26. The process of claim 25, wherein removing sharp and loose skin from the dried segments comprises tumbling the dried segments.

27. The process of claim 26, wherein tumbling the dried segments comprises:
placing the dried segments into a tumbling apparatus having exit holes;
activating the tumbling apparatus to remove the sharp and loose skin; and
permitting removed skin to exit from the tumbling apparatus via the exit holes.

28. The process of claim 16, wherein substantially all of the starch in the at least one sweet potato is converted to sugar.

29. A process for making animal chew products, comprising:
baking at least one sweet potato to reach a conversion temperature for a time sufficient to generally uniformly convert starch in the at least one sweet potato to sugar while retaining sufficient structure in the at least one sweet potato to permit its slicing into segments of a desired shape and thickness;
slicing the baked at least one sweet potato into the segments; and
applying heat at a drying temperature that is below the burning point of the sugar for a time sufficient to dry the segments to a threshold moisture level.

30. The process of claim 29, wherein the thickness of the segments is about 0.5 inches prior to being dried.

31. The process of claim 29, wherein the threshold moisture level is about 8% to about 20%.

32. The process of claim 29, wherein during the baking substantially all of the starch in the at least one sweet potato is converted to sugar.

33. An animal chew product made by the process of claim 1.

34. An animal chew product made by the process of claim 16.

35. An animal chew product made by the process of claim 29.
